(19) United States
(12) Patent Application Publication
(10) Pub. No.: US 2007/0097930 A1
(43) Pub. Date: May 3, 2007

(54) Method of implementing the Multi-MCS-Multi-Receiver Aggregation'' scheme in IEEE 802.11n standard

(75) Inventors: Xuemei Ouyang, San Jose, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/261,727

(22) Filed: Oct. 27, 2005

(51) Int. Cl. H04Q 7/24

(52) U.S. Cl. 370/338

(57) ABSTRACT

A method of communicating data over a wireless local area network according to an IEEE 802.11n proposal for Multi-MCS-Multi-Receiver Aggregation (MMRA), the improvement providing a modified PPDU format with MMRA signaling wherein the HT-SIG format is preserved. Instead of increasing the length of HT-SIG, a modified PPDU format with MMRA signaling is provided where the HT-SIG-MMRA is placed after the HT-LTF. In this manner, the original HT-SIG format is preserved, while accommodating the variable length of HT-SIG-MMRA. Further, in a modified HT-SIG structure, the Length and MCS of the HT-SIG-MMRA signaling part is placed in the LENGTH field and MCS field of HT-SIG1 (4 us), respectively, without changing the length of existing HT-SIG (8 us).

### FIELD OF THE INVENTION

The present invention relates generally to data communication, and more particularly, to data communication in wireless local area network (WLAN) environment.

### BACKGROUND OF THE INVENTION

The IEEE 802.11n standard provides for data communication, and more particularly, to data communication in WLAN environments. In IEEE 802.11n development process, a Multi-MCS-Multi-Receiver Aggregation (MMRA) mechanism has been proposed to increase the wireless LAN (WLAN) efficiency.

Implementing Multi-MCS-Multi-Receiver Aggregation (MMRA) requires a modification in the physical layer (PHY) aggregation. Compared to MRA, the MMRA technique can aggregate multiple packets with different transmission rates (MCS). MRA always uses the same MCS to transmit the aggregated packet to multiple receivers.

FIG. 1 shows the PHY Protocol Data Unit (PPDU) format for MIMO transmission, wherein the HT-SIG-MMRA (High Throughput Signal Field MMRA) signaling part is placed before the HT-STF (High Throughput Short Training Field). This required a fixed number of bits for the MCS (modulation and coding scheme), and a variable number of bits for the length of MMRA signaling part in HT-SIG1. Since HT-SIG field is running out of bits, it is difficult to add more bits in it unless the length of HT-SIG field is increased. However, as HT-SIG is to be transmitted in the most robust data rate, i.e., 6 Mbps, increasing the length of HT-SIG will largely increase the overhead of existing PPDU.

### BRIEF SUMMARY OF THE INVENTION

In one embodiment the present invention provides a method of communicating data over a wireless local area network according to an IEEE 802.11n proposal for Multi-MCS-Multi-Receiver Aggregation (MMRA), the improvement comprising providing a modified PPDU format with MMRA signaling wherein the HT-SIG format is preserved.

Instead of increasing the length of HT-SIG, a modified PPDU format with MMRA signaling is provided where the HT-SIG-MMRA is placed at the end of HT-LTF. In this manner, the original HT-SIG format described in S. A. Mujtaba, “TGn Sync Proposal Technical Specification,” a contribution to IEEE.802.11, 11-04-889r1, November 2004 (incorporated herein by reference) is preserved, while accommodating the variable length of HT-SIG-MMRA.

Further, in a modified HT-SIG structure according to an embodiment of the present invention, the Length and MCS of the HT-SIG-MMRA signaling part is placed in the LENGTH field and MCS field of HT-SIG1 (4 us), respectively, without changing the length of existing HT-SIG (8 us).

Further, two bits in HT-SIG2 (4 us) indicate aggregation: AGGREGATION and MRA bits.

These and other features, aspects and advantages of the present invention will become understood with reference to the following description, appended claims and accompanying figures.

### BRIEF DESCRIPTION OF THE DRAWINGS

FIG. 1 shows a PPDU format for basic MIMO transmission.

FIG. 2 shows an example modified PPDU format with MMRA signaling according to an embodiment of the present invention.

FIG. 3 shows an example HT-SIG format in the PPDU format of FIG. 2 according to an embodiment of the present invention.

FIG. 4 shows a HT-SIG-MMRA Part transmission format.

### DETAILED DESCRIPTION OF THE INVENTION

Initial 802.11 stations typically send frames in the order they are received. For throughput purposes, it is highly desirable to reorder frames so that they can coalesce into larger aggregated frames. Aggregation in TGnSync is a MAC-layer function that bundles several MAC frames into a single PLCP (Physical Layer Convergence Protocol) frame for transmission.

A single physical-layer frame contains several MAC layer frames. Several MAC frames are put into the same PLCP frame, with an appropriate delimiter between them. The delimiter has a small reserved field, a length field for the following MAC frame, a CRC to protect the delimiter, and a unique pattern to assist in recovering individual frames from the aggregate. MAC frames are put into the aggregate without modification, and contain the full header and MAC CRC. Even if one frame out of an aggregate is lost, it may be possible to successfully receive all the remaining frames.

However, the benefits of aggregation in TGnSync are not confined to pairs. Single-receiver aggregation is required; an optional extension allows aggregate frames to contain MAC frames for multiple receivers, in which case they are called Multiple Receiver Aggregate (MRA) frames. Inside the single rate transmitted aggregate frame, there are multiple Initiator Access Control frames. Each IAC specifies an offset to transmit the response to the aggregated frames, which will usually be a block acknowledgment response. To distinguish multiple receiver aggregate frames from single-receiver aggregate frames, multiple-receiver frames start with a control item called the Multiple Receiver Aggregate Descriptor (MRAD). The initiator's aggregate frame starts with the aggregate descriptor, and is followed by the aggregated frames for each destination. (802.11 Wireless Networks: The Definitive Guide, Second Edition”, by Matthew Gast, Second Edition, Ch. 15, April 2005 ISBN: 0-596-10052-3).

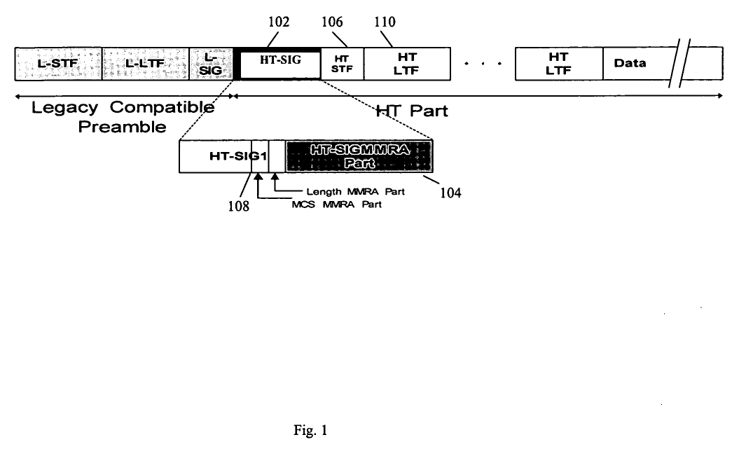

Implementing Multi-MCS-Multi-Receiver Aggregation (MMRA) requires a modification in the physical layer (PHY) aggregation. In IEEE 802.11n development process, a Multi-MCS-Multi-Receiver Aggregation (MMRA) mechanism has been proposed to increase the wireless LAN (WLAN) efficiency, as described in the TGnSync Technical Proposal in the attached Appendix. As noted, FIG. 1 shows the PHY Protocol Data Unit (PPDU) format 100, wherein the HT-SIG-MMPA (High Throughput Signal Field MMRA) signaling part 104 of the HT-SIG field 102 is placed before the HT-STF (High Throughput Short Training Field) 106. This required a fixed number of bits for the MCS (modulation and coding scheme), and a variable number of bits for the length of MMRA signaling part in HT-SIG1 field 108. Since HT-SIG field 102 is running out of bits, it is difficult to add more bits in it unless the length of HT-SIG field 102 is increased. However, as HT-SIG 102 is to be transmitted in the most robust data rate, i.e., 6 Mbps, increasing the length of HT-SIG 102 will largely increase the overhead of existing PPDU.

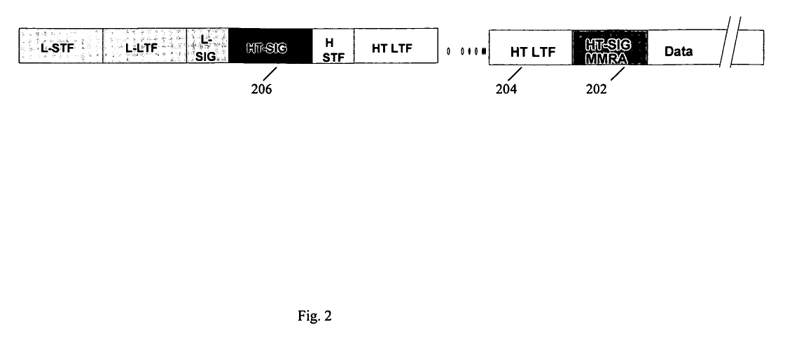

According to one embodiment of the present invention shown by example in FIG. 2, instead of increasing the length of HT-SIG 102, a modified PPDU format 200 with MMRA signaling is provided where the HT-SIG-MMRA field 202 is placed at the end of HT-LTF 204. In this manner, the original HT-SIG format 206 (described in S. A. Mujtaba, “TGn Sync Proposal Technical Specification,” a contribution to IEEE.802.11, 11-04-889r1, November 2004 (incorporated herein by reference) is preserved, while accommodating the variable length of HT-SIG-MMRA 202.

After moving the HT-SIG-MMRA 202 to the location after the HT-LTF 204, the HT-SIG-MMRA 202 can be transmitted in higher data rate, compared with the lowest data rate transmission in conventional systems. The modified format 200 (FIG. 2) according to an embodiment of the present invention requires less time to be transmitted than the format 100 (FIG. 1) where HT-SIG-MMRA 104 was in front of HT-LTF 110, which can only be transmitted through the lowest data rate of 6 Mbps.

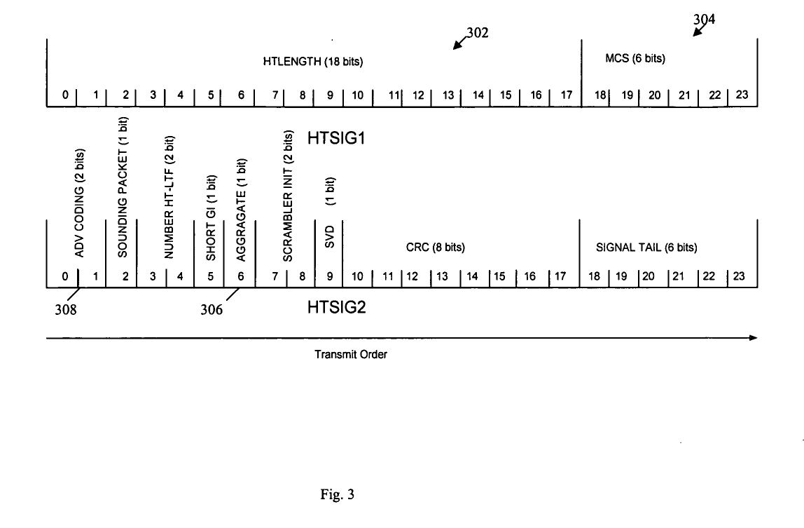

Further, referring to FIG. 3, showing a modified HT-SIG structure 300 including fields HT-SIG1 and HT-SIG2, according to an embodiment of the present invention, the Length and MCS of the HT-SIG-MMRA signaling part is placed in the LENGTH field 302 and MCS field 304 of HT-SIG1 (4 us), respectively, without changing the length of existing HT-SIG (8 us).

Two bits in HT-SIG2 (4 us) indicate aggregation i.e. SMRA (Single MCS Multiple Receiver Aggregation), and MMRA, wherein: the AGGREGATION bit 306 indicates weather it is an aggregated packet and one more bit to indicate MMRA (e.g., the spare bit from ADV coding 308 can be used).

With AGGREGATION and MRA bits, the HT-SIG1 field can be interpreted by a receiver as:

AGGREGATION=0: Without aggregation, LENGTH and MCS fields in HT-SIG1 are interpreted as the length and MCS of the transmitting PSDU (PHY Service Data Unit), respectively.

AGGREGATION=1: With aggregation, MRA=0->SMRA, such that when MRA=0, the transmitting packet is a SMRA packet.

LENGTH and MCS fields 302, 304, in HT-SIG1 are interpreted by a receiver as the length and MCS of the transmitting PSDU, respectively. The LENGTH indicates the whole aggregated packet length. For example, two packet aggregates to a single PSDU, their length are l1 and l2 byte respectively. The LENGTH field in this case is l1+l2 bytes.

AGGREGATION=1: With aggregation, MRA=1->MMRA, such that when MRA=1, the transmitting packet is a MMRA packet.

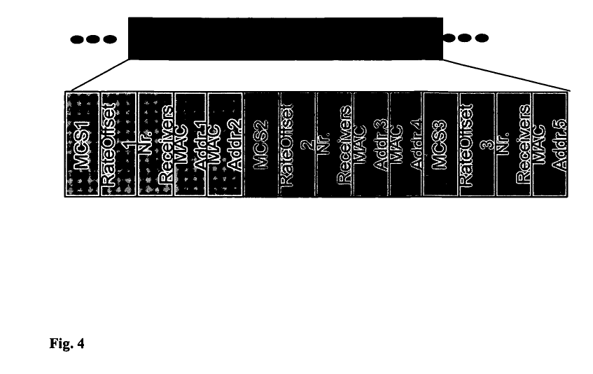

LENGTH and MCS fields in HT-SIG1 are interpreted by a receiver as the Length and MCS of HT-SIG-MMRA, respectively. The Length and MCS for each aggregated packet are indicated in HT-SIG-MMRA. In one example, two packets are to be aggregated. One packet has length of 11 bytes and should be transmitted with MCS1. The other packet has length of l2 bytes and should be transmitted with MCS2. The value of l1, MCS1 and l2, MCS2 are placed into HT-SIG-MMRA 400 as shown in FIG. 4 which should be transmitted at rate MCS3. LENGTH and MCS fields in HT-SIG1 will be l3 and MCS3, respectively.

The present invention has been described in considerable detail with reference to certain preferred versions thereof; however, other versions are possible. Therefore, the spirit and scope of the appended claims should not be limited to the description of the preferred versions contained herein.

What is claimed is:

1. In a method of communicating data over a wireless local area network according to an IEEE 802.11 standard for Multi-MCS-Multi-Receiver Aggregation (MMRA), the improvement comprising:
providing a modified PPDU format with MMRA signaling wherein the HT-SIG format is preserved.

2. The method of claim 1 wherein the modified PPDU format further accommodates variable length of HT-SIG-MMRA.

3. The method of claim 1 wherein in the modified PPDU format, the HT-SIG-MMRA is placed after the HT-LTF, whereby the HT-SIG format is preserved while accommodating the variable length of HT-SIG-MMRA.

4. The method of claim 3 wherein in the modified PPDU format, the Length and MCS of the HT-SIG-MMRA signaling part is placed in the LENGTH field and MCS field of HT-SIG1 (4 us), respectively, without changing the length of existing HT-SIG (8 us).

5. The method of claim 4 wherein two bits in HT-SIG2 (4 us) indicate aggregation: SMRA (Single MCS Multiple Receiver Aggregation), and MMRA.

6. The method of claim 4 wherein two bits in HT-SIG2 (4 us) indicate aggregation: AGGREGATION and MRA bits.

7. The method of claim 6 further including the steps of interpreting the HT-SIG1 field as:
AGGREGATION=0: Without aggregation,
LENGTH and MCS fields in HT-SIG1 are interpreted by a receiver as the length and MCS of PSDU, respectively.

8. The method of claim 6 further including the steps of interpreting the HT-SIG1 field in a receiver as:
AGGREGATION=1: With aggregation, when MRA=0, the transmitting packet is a SMRA packet,
LENGTH and MCS fields in HT-SIG1 are interpreted as the length and MCS of PSDU, respectively.

9. The method of claim 6 further including the steps of interpreting the HT-SIG1 field in a receiver as:
AGGREGATION=1: With aggregation, when MRA=1, the transmitting packet is a MMRA packet,
LENGTH and MCS fields in HT-SIG1 are interpreted as the length and MCS of HT-SIG-MMRA, respectively.

10. The method of claim 3, wherein the modified format allows data transmission with higher data rate, thereby shortening transmission time.

11. The method of claim 3, wherein the modified format allows data transmission with higher data rate, thereby shortening transmission time relative to HT-SIG with a transmission rate of 6 Mbps.

12. A communication system comprising:
a wireless local area network according to an IEEE 802.11 standard for Multi-MCS-Multi-Receiver Aggregation (MMRA), utilizing a modified PPDU format with MMRA signaling wherein the HT-SIG format is preserved.

13. The system of claim 12 wherein the modified PPDU format further accommodates variable length of HT-SIG-MMRA.

14. The method of claim 12 wherein in the modified PPDU format, the HT-SIG-MMRA is placed at the end of HT-LTF, whereby the HT-SIG format is preserved while accommodating the variable length of HT-SIG-MMRA.

15. The system of claim 14 wherein in the modified PPDU format, the Length and MCS of the HT-SIG-MMRA signaling part is placed in the LENGTH field and MCS field of HT-SIG1 (4 us), respectively, without changing the length of existing HT-SIG (8 us).

16. The system of claim 15 wherein two bits in HT-SIG2 (4 us) indicate aggregation: SMRA (Single MCS Multiple Receiver Aggregation), and MMRA.

17. The system of claim 16 wherein two bits in HT-SIG2 (4 us) indicate aggregation: AGGREGATION and MRA bits.

18. The system of claim 17 wherein the HT-SIG1 field is interpreted in a receiver as:
AGGREGATION=0: Without aggregation,
LENGTH and MCS fields in HT-SIG1 are interpreted as the length and MCS of PSDU, respectively.

19. The system of claim 18 wherein the HT-SIG1 field is interpreted in a receiver as:
AGGREGATION=1: With aggregation, when MRA=0, the transmitting packet is a SMRA packet,
LENGTH and MCS fields in HT-SIG1 are interpreted as the length and MCS of PSDU, respectively.

20. The system of claim 17 wherein the HT-SIG1 field is interpreted in a receiver as:
AGGREGATION=1: With aggregation, when MRA=1, the transmitting packet is a MMRA packet,
LENGTH and MCS fields in HT-SIG1 are interpreted as the length and MCS of HT-SIG-MMRA, respectively.
